(19) United States
(12) Patent Application Publication
(10) Pub. No.: US 2024/0302835 A1
(43) Pub. Date: Sep. 12, 2024

(54) CONTROL MODES FOR HYBRID VEHICLES

(71) Applicants: Hyundai Motor Company, Seoul (KR); Kia Corporation, Seoul (KR)

(72) Inventors: Ernestine Fu, Somerville, MA (US); John Suh, Palo Alto, CA (US)

(21) Appl. No.: 18/181,289

(22) Filed: Mar. 9, 2023

(51) Int. Cl. G05D 1/00; B62D 57/028; G05D 1/02

(52) U.S. Cl. CPC G05D 1/0016; B62D 57/028

(57) ABSTRACT

Systems and methods for controlling a hybrid vehicle are provided. The hybrid vehicle may comprise a chassis, a plurality of leg-wheel components coupled to the chassis, wherein the plurality of leg-wheel components may be configured to be collectively operable to provide wheeled locomotion and walking locomotion. The hybrid vehicle may comprise at least one sensor configured to receive one or more external commands during a supplementary control mode, and an external command interpreter configured to interpret the one or more external commands and direct a vehicle control system. The vehicle control system may be configured to control the hybrid vehicle to effectuate the one or more external commands.

### BACKGROUND

### Technical Field

Embodiments of the present disclosure relate to systems and methods for controlling a vehicle capable of locomotion using both walking motion and rolling traction.

### Background

Conventional passenger motor vehicles are designed to primarily move in a forward direction using wheeled locomotion. These conventional motor vehicles are typically controlled using a steering wheel configured to control the direction of travel of the vehicle and two (or three) foot pedals configured to control acceleration and braking (and, in a manual transmission, shifting gears). While innovation in the automobile industry has changed the driving experience, control of vehicles using a steering wheel and standard foot pedals has not fundamentally changed since the mass-production of automobiles.

Current user interfaces for controlling conventional motor vehicles are not able to provide control for vehicles having wheeled and walking motion and being capable of omnidirectional movement.

### SUMMARY

Embodiments described herein provide supplementary control modes for control of a vehicle capable of locomotion using both walking motion and rolling traction, also referred to herein as a “hybrid vehicle.” Control of such a hybrid vehicle is a complex endeavor relative to control of a conventional motor vehicle capable of only wheeled locomotion. As the use cases of such hybrid vehicles is potentially quite vast, the circumstances of controlling hybrid vehicles in a wide array of different uses necessitates novel approaches. The described embodiments provide enhanced control modes for potential use in different situations in which a hybrid vehicle may be used.

According to an object of the present disclosure, a hybrid vehicle is provided. The hybrid vehicle may comprise a chassis, a plurality of leg-wheel components coupled to the chassis, wherein the plurality of leg-wheel components may be configured to be collectively operable to provide wheeled locomotion and walking locomotion. The hybrid vehicle may comprise at least one sensor configured to receive one or more external commands during a supplementary control mode, and an external command interpreter configured to interpret the one or more external commands and direct a vehicle control system. The vehicle control system may be configured to control the hybrid vehicle to effectuate the one or more external commands.

According to an exemplary embodiment, the supplementary control mode may comprise a sign mode. In the sign mode, the hybrid vehicle may be configured to be controlled by an operator, external to the hybrid vehicle. The operator may be configured to control operation of the hybrid vehicle by issuing the one or more external commands using sign language.

According to an exemplary embodiment, the at least one sensor may comprise an image sensor.

According to an exemplary embodiment, the supplementary control mode may comprise a follow mode. In the follow mode, the hybrid vehicle may be configured to follow a lead vehicle.

The lead vehicle may be configured to control operations of the hybrid vehicle.

According to an exemplary embodiment, the at least one sensor may comprise an image sensor.

According to an exemplary embodiment, the one or more external commands may be issued by the lead vehicle by a material deposition.

According to an exemplary embodiment, the at least one sensor may comprise a beacon receiver.

According to an exemplary embodiment, the one or more external commands may be issued by the lead vehicle by a beacon transmitter.

According to an exemplary embodiment, the at least one sensor may comprise a touch sensor on an external surface of the hybrid vehicle.

According to an exemplary embodiment, the hybrid vehicle may comprise one or more touch sensors. The supplementary control mode may comprise a touch mode, and, in the touch mode, the hybrid vehicle may be configured to be controlled through the one or more touch sensors.

According to an object of the present disclosure, a system for controlling a hybrid vehicle is provided. The system may comprise a hybrid vehicle, comprising a chassis, a plurality of leg-wheel components coupled to the chassis, wherein the plurality of leg-wheel components are configured to be collectively operable to provide wheeled locomotion and walking locomotion, at least one sensor configured to receive one or more external commands during a supplementary control mode, and a vehicle control system configured to control the hybrid vehicle to effectuate the one or more external commands. The hybrid vehicle may comprise a computing device, comprising a processor and a memory, configured to store programming instructions. The programming instructions, when executed by the processor, may be configured to cause the processor to, using an external command interpreter, interpret the one or more external commands and direct the vehicle control system to effectuate the one or more external commands.

According to an exemplary embodiment, the supplementary control mode may comprise a sign mode. In the sign mode, the hybrid vehicle may be configured to be controlled by an operator, external to the hybrid vehicle. The operator may be configured to control operation of the hybrid vehicle by issuing the one or more external commands using sign language.

According to an exemplary embodiment, the at least one sensor may comprise an image sensor.

According to an exemplary embodiment, the system may comprise a lead vehicle and the supplementary control mode may comprise a follow mode. In the follow mode, the hybrid vehicle may be configured to follow the lead vehicle. The lead vehicle may be configured to control operations of the hybrid vehicle.

According to an exemplary embodiment, the at least one sensor may comprise an image sensor.

According to an exemplary embodiment, the lead vehicle may be configured to issue the one or more external commands by a material deposition.

According to an exemplary embodiment, the at least one sensor may comprise a beacon receiver.

According to an exemplary embodiment, the lead vehicle may be configured to issue the one or more external commands by a beacon transmitter.

According to an exemplary embodiment, the at least one sensor may comprise a touch sensor on an external surface of the hybrid vehicle.

According to an exemplary embodiment, the hybrid vehicle may comprise one or more touch sensors and the supplementary control mode may comprise a touch mode. In the touch mode, the hybrid vehicle may be configured to be controlled through the one or more touch sensors.

### BRIEF DESCRIPTION OF THE DRAWINGS

The accompanying drawings, which are incorporated in and form a part of the Description of Embodiments, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIGS. 1A through 1C illustrate a hybrid vehicle capable of omnidirectional movement using both walking motion and rolling motion, according to an exemplary embodiment of the present disclosure.

FIGS. 2A and 2B illustrate a leg-wheel component in retracted and extended positions, according to an exemplary embodiment of the present disclosure.

FIG. 2C is a diagram illustrating a low range of motion suspension stage and a high range of motion suspension stage, according to an exemplary embodiment of the present disclosure.

FIGS. 3A through 3C illustrate perspective views of different walking gaits of a hybrid vehicle, according to exemplary embodiments of the present disclosure.

FIG. 4 is a block diagram of a system for providing supplementary control modes for control of a hybrid vehicle, according to exemplary embodiments of the present disclosure.

FIG. 5 is a diagram illustrating a hybrid vehicle operating in a sign mode, in accordance with an exemplary embodiment of the present disclosure.

FIGS. 6A and 6B are diagrams illustrating hybrid vehicles operating in a follow mode, in accordance with exemplary embodiments of the present disclosure.

FIG. 7 is a diagram illustrating a hybrid vehicle operating in a touch mode, in accordance with an exemplary embodiment of the present disclosure.

FIG. 8 illustrates example elements of a computing device, according to an exemplary embodiment of the present disclosure.

FIG. 9 illustrates an example architecture of a vehicle, according to an exemplary embodiment of the present disclosure.

### DETAILED DESCRIPTION

The following Description of Embodiments is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

According to an exemplary embodiment, a vehicle capable of both wheeled locomotion and walking locomotion is provided, in accordance with exemplary embodiments of the present disclosure. An example system for providing supplementary control modes for control of a hybrid vehicle is provided, in accordance with exemplary embodiments of the present disclosure.

Embodiments described herein provide supplementary control modes for control of a vehicle capable of locomotion using both walking motion and rolling traction, also referred to herein as a “hybrid vehicle.” Control of such a hybrid vehicle is a complex endeavor relative to control of a conventional motor vehicle capable of only wheeled locomotion. As the use cases of such hybrid vehicles is potentially quite vast, the circumstances of controlling hybrid vehicles in a wide array of different uses necessitates novel approaches. The described embodiments provide enhanced control modes for potential use in different situations in which a hybrid vehicle may be used.

In an exemplary embodiment, the supplementary control mode may comprise a sign mode in which an operator external to the hybrid vehicle controls operation of the hybrid vehicle by issuing commands using sign language. The sign language may be captured by at least one image sensor of the hybrid vehicle and may be interpreted to form one or more commands at a human-machine interface of the hybrid vehicle. The sign mode may be configured to not require an external device to be used, and may be configured to allow for control of a hybrid vehicle without any electronic or data connection to the hybrid vehicle. For example, such control may be useful due to a high noise environment (e.g., firefighting) or a low noise environment (e.g., military stealth mission) in which a hybrid vehicle is used. It should be appreciated that the sign language used may be universal, such as American Sign Language (ASL), specific to a situation, and/or coded for additional security (e.g., signs used by players and managers in sports).

In an exemplary embodiment, the supplementary control mode may comprise a follow mode in which one or more hybrid vehicles may be configured to follow a lead vehicle which may be configured to control operations of the subservient hybrid vehicles. The follow mode may be engaged by using a beacon carried on a lead vehicle (e.g., an electronic beacon device or other communication device). In other exemplary embodiments, the follow mode may be configured to be engaged using sign language, as described in the sign mode. In some exemplary embodiments, the follow mode may be configured to be instantiated by the lead vehicle using a paint or equivalent material in order to create a path or other instruction that may be imaged at an image sensor of a subservient vehicle and interpreted using a vehicle control system in order to identify commands of the deposited material. Such deposited material may be temporary or permanent, and may be of a visible material or an invisible material (to the human eye) and may be configured to utilize a special image sensor or filter to capture (e.g., ultraviolet paint). The commands identified by the deposited material may be active for a period of time different from the period of visibility of the deposited material. In some exemplary embodiments, the lead vehicle may be configured to use the follow mode by issuing commands using ambulatory limbs (e.g., leg-wheel components) of the lead vehicle. For example, the subservient vehicle that is controlled by the follow mode may be configured to perform preparatory work by, e.g., carrying gear and equipment for a team on a mission.

In an exemplary embodiment, the supplementary control mode may comprise a touch mode in which a hybrid vehicle may be controlled through one or more touch interfaces on an exterior of the hybrid vehicle. In such an embodiment, an operator of the hybrid vehicle may touch the one or more touch interfaces on the hybrid vehicle in order to pick-and-place its leg-wheel components or perform other control functions. It should be appreciated that the hybrid vehicle may comprise one or more touch interfaces on each leg-wheel component, each portion of each leg-wheel component, the chassis, and/or any combination thereof. For example, the touch control may be configured to be limb specific, or may be instantiated by a central touch control (such as, e.g., for very small or very large vehicles). It should be appreciated that additional information may be conveyed through the touch interface using taps, swipes and/or other known gestures (e.g., for security, actuation, selection, fine control, etc.). Moreover, the touch interfaces may comprise display devices (e.g., a touch screen) configured to display information, or may comprise touch only interfaces without an integrated display device.

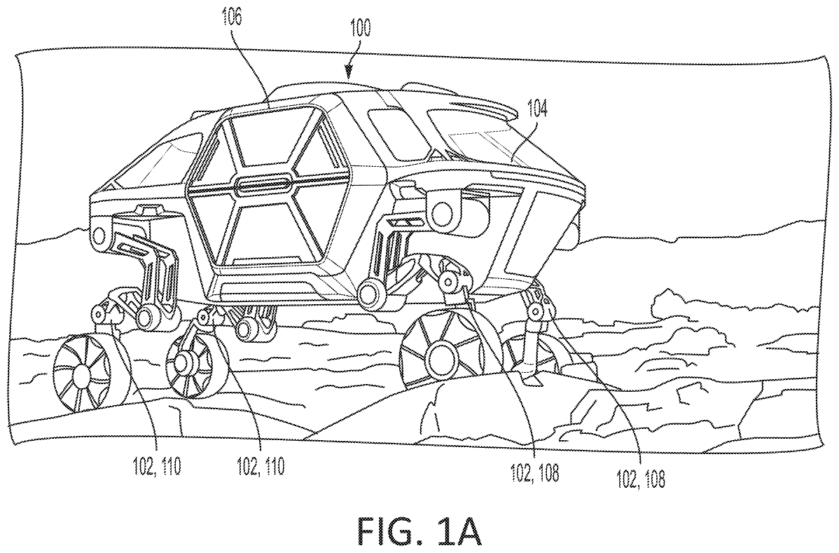

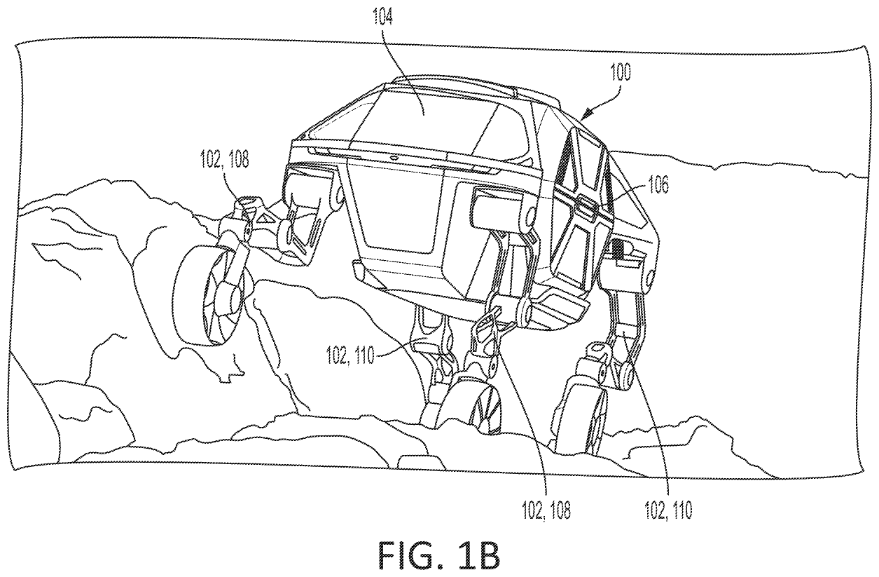

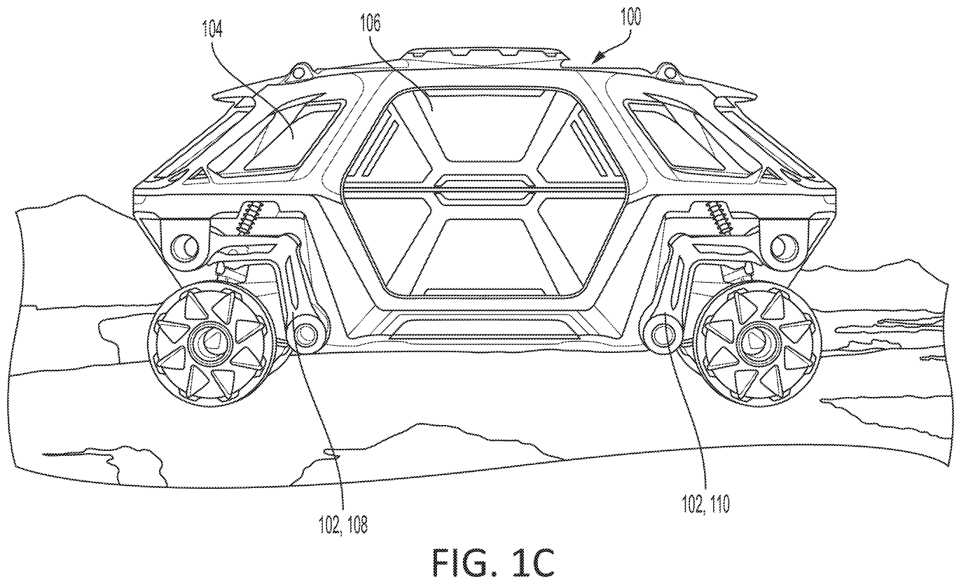

Referring now to FIGS. 1A through IC, a hybrid vehicle 100 capable of, and configured to perform, omnidirectional movement using both walking motion and rolling motion, is illustratively depicted, according to exemplary embodiments of the present disclosure. FIGS. 1A and 113 illustrate the hybrid vehicle 100 in different walking locomotion positions across rugged terrain, where hybrid vehicle 100 is capable of omnidirectional movement. FIG. 1C illustrates a side view of hybrid vehicle 100.

Hybrid vehicle 100 may comprise four leg-wheel components 102, each configured to perform movement with at least two degrees of freedom. It is noted, however, that other numbers of leg-wheel components 102 may be incorporated, while maintaining the spirit and functionality of the present disclosure. As illustrated, hybrid vehicle 100 may comprise a passenger compartment 104 configured to hold one or more people. It should be appreciated that hybrid vehicle 100, in some exemplary embodiments, may be configured to be operated by an onboard operator, may be configured to be operated remotely, and/or may be configured to be operated autonomously.

In an exemplary embodiment, the leg-wheel components 102 may be configured to perform movement with at least six degrees of freedom. It should be appreciated that, while the leg-wheel components 102 may be configured to be controlled collectively in order to provide rolling and walking locomotion, each leg-wheel component 102 may be capable of performing different movement or positioning, from the one or more other lag-wheel components 102, during operation. For example, while using wheeled locomotion on an upward slope, in order to maintain a body 114 and chassis 106 of the hybrid vehicle 100 level with flat ground, the front leg-wheel components 108 may be retracted and the rear leg-wheel components 110 may be extended. In an exemplary embodiment, while using walking locomotion to traverse rough terrain, each leg-wheel component 102, or opposite pairs of the leg-wheel components 102 (e.g, front left and rear right), may be configured to move differently from the other leg-wheel components 102. The leg-wheel components 102 may be configured to operate to move the hybrid vehicle 100 in any direction of travel, and may be configured to change direction(s) at any time.

Various aspects of control for the hybrid vehicle 100 may be controlled by either an operator and/or the hybrid vehicle 100 itself, depending on the operation mode. In general, a number of aspects of the operation may be subject to different types of operator control. For example, aspects that may be controlled in operating the hybrid vehicle 100 may comprise one or more objectives of the hybrid vehicle 100, one or more destinations of the hybrid vehicle 100, a speed and direction of travel, a type of locomotion used (e.g., wheeled, walking, and/or a combination), the position of one or more leg-wheel components 102 when in walking locomotion, controlling the walking gait when in walking locomotion, etc. Moreover, in controlling the operation of a hybrid vehicle 100, different vehicle operation modes are described that may afford different types of operation to the hybrid vehicle 100 operator. In general, the vehicle operation modes may be configured to cover modes in which an onboard operator is in complete control of vehicle operation to modes in which an operator (onboard or remote) may provide the hybrid vehicle 100 with objectives that the hybrid vehicle 100 may interpret, which the hybrid vehicle 100 may then implement to accomplish the objectives.

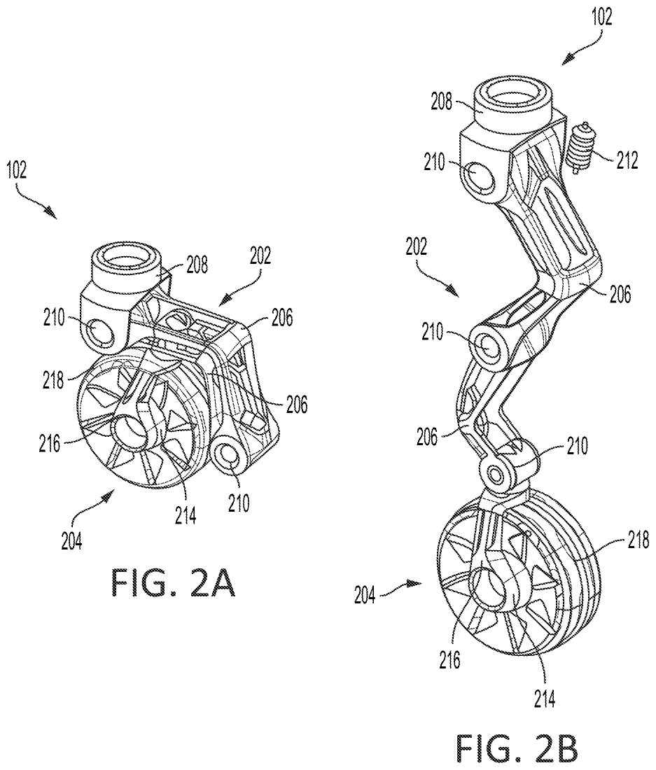

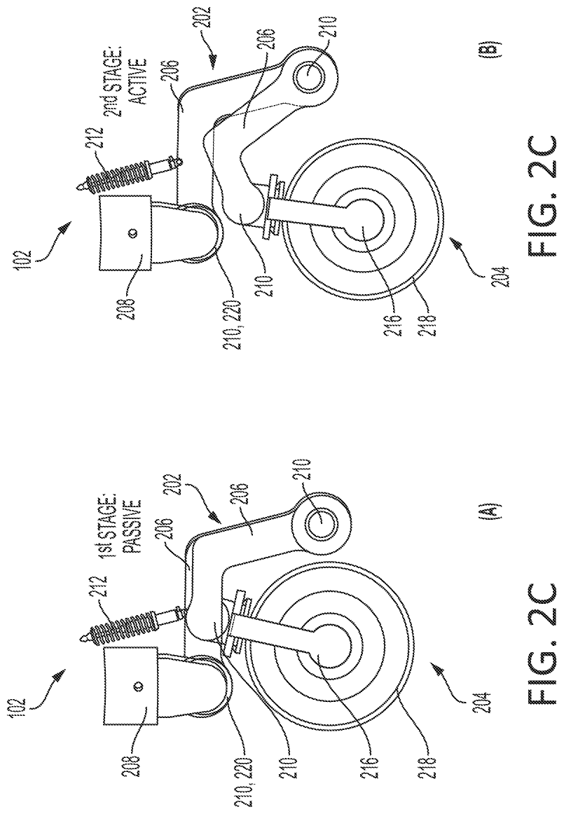

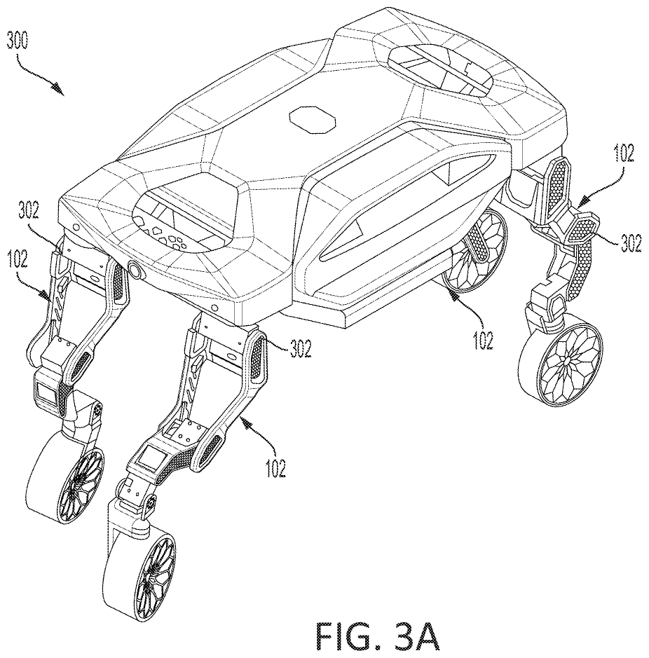

Referring now to FIGS. 2A and 2B, an example leg-wheel component 102 in a retracted position (FIG. 2A) and an extended position (FIG. 2B), are illustratively depicted, in accordance with an exemplary embodiment of the present disclosure.

Various embodiments of such leg-wheel components 102 are described, e.g., in co-pending U.S. patent application Ser. No. 16/734,310 (U.S. Patent Application Publication No. 2020/0216127). It is noted that other configurations of one or more leg-wheel components 102 may be incorporated into the present disclosure, while maintaining the spirit and functionality of the present disclosure.

The leg-wheel component 102 may comprise a leg component 202 and a wheel component 204. The wheel component 204 may be coupled to the leg component 202.

According to an exemplary embodiment, the leg-wheel component 102 may comprise a coupling component 208 configured to couple the leg-wheel component 102 to the body 104, frame, or other suitable component of the hybrid vehicle 100.

The leg component 202 may be divided into one or more segments 206. The one or more segments 206, coupling component 208, and/or the wheel component 204 may be configured to rotate about each other via one or more movable joint components 210. According to an exemplary embodiment, the leg-wheel component 102 may comprise one or more suspension systems 212 (e.g., springs, shock absorbers, etc).

According to an exemplary embodiment, the wheel component 204 may be configured to rotate along an axis while coupled to the leg component 202, enabling the hybrid vehicle 100 to move along a surface in contact with the wheel component 204. According to an exemplary embodiment, the leg-wheel component 102 may comprise one or more braking mechanisms for preventing and/or decreasing rotation of the wheel component 204.

With reference to FIG. 2A, the leg-wheel component 102 (a hybrid vehicle 100 traversal component) is in a retracted state, with the leg-wheel component 102 being configured and positioned to provide wheeled locomotion. With reference to FIG. 2B, the leg-wheel component 102 is in an extended state, with the leg-wheel component 102 being configured and positioned to provide walking locomotion and/or wheeled locomotion.

According to an exemplary embodiment, wheeled locomotion may be available for use in situations where traditional vehicle travel using rolling wheels 204 is available (e.g., roads and highways). Wheeled locomotion is efficient, when available, for conveyance of a vehicle (e.g., hybrid vehicles 100, 300, 500, 600, 610a, 610b, 610c, 650, 660, 700) between destinations.

According to some exemplary embodiments, the leg-wheel components 102 may be configured to allow for active height adjustment of the hybrid vehicle 100, enabling the hybrid vehicle 100 to go, e.g., from street use to off-road use.

In walking locomotion, the hybrid vehicle 100 may be configured to walk up elevations and terrain that is not surmountable using wheeled locomotion. In some instances, walking locomotion allows for nimble and quiet motion, relative to wheeled locomotion. The hybrid vehicle 100 may also be configured to move laterally, allowing for quadrupedal ambulation.

According to an exemplary embodiment, the leg-wheel component 102 comprises one or more in-wheel motors 214 configured to power movement of the wheel component 204 and/or the leg component 202. The use of in-wheel motors 214 frees the suspension 212 from traditional axles and allows for ambulation, but also increases the driving performance and adaptability.

By using the wheels 204 as feet, the electric motors 214 may be configured to lock for stable ambulation, but also may have slow torque controlled rotation for micro movements when climbing or during self-recovery. According to some exemplary embodiments, the wheel 204 of the leg-wheel component 102 may be configured to rotate 180 degrees perpendicular to a hub 216, not only allowing leaning capability while driving, but also giving the wheels 204 enhanced positioning potential when a tire 218 is locked and in walking mode. The wheel 204 may be configured to turn 90 degrees and even may be configured to be used as a wide foot pad, lowering the hybrid vehicle's 100 pounds per square inch (PSI) footprint when walking over loose materials or fragile surfaces, similar to that of a snowshoe.

Referring now to FIG. 2C, a diagram indicating a low range of motion suspension stage ((A), a passive stage), and a high range of motion suspension stage ((B), an active stage) of a leg-wheel component 102 is illustratively depicted, in accordance with an exemplary embodiment of the present disclosure.

According to an exemplary embodiment, the leg-wheel component 102 may be configured to provide two-stage suspension: a first, low range of motion suspension stage, when the hybrid vehicle 100 leg-wheel component 102 is in a retracted position (A), and a second, high range of motion suspension stage, when the hybrid vehicle 100 leg-wheel component 102 is in an extended position (B).

According to an exemplary embodiment, in the low range of motion suspension stage, a suspension system 212 (e.g., a coil-over suspension) is utilized and engaged when the hybrid vehicle 100 leg-wheel component 102 is in the retracted position. According to an exemplary embodiment, while in the low range of motion suspension stage, the a knee joint component 220 of the leg-wheel component 102 may be relaxed, while the remaining joints 210 of the leg-wheel component 102 may be locked. During the low range of motion suspension stage, the leg-wheel component 102 may be configured to handle high-frequency vibrations through the chassis-mounted suspension system 212. According to an exemplary embodiment, when the leg-wheel component 102 is retracted and the low range of motion suspension stage is enabled, the hybrid vehicle 100 may be configured to provide 0 to 5 inches of suspension during wheeled locomotion. It is noted, however, that other amounts of suspension may be incorporated while maintaining the spirit and functionality of the present disclosure.

According to an exemplary embodiment, in the high range of motion suspension stage, the suspension system 212 (e.g., the coil-over suspension) may be disengaged when the leg-wheel component 102 is in an extended or actuated position. For example, the suspension system 212 may be configured to remain with the chassis during the high range of motion suspension stage, and the knee joint 220 may be driven by a motor in order to provide suspension. According to an exemplary embodiment, during the high range of motion suspension stage, the leg-wheel component 102 may be configured to support advanced driving dynamics through the capabilities of a motor at the knee joint 220. According to an exemplary embodiment, when the leg-wheel component 102 is extended and the high range of motion suspension stage is enabled, the hybrid vehicle 100 may be configured to provide 5 to 50 inches of suspension during walking locomotion. It is noted, however, that other amounts of suspension may be incorporated while maintaining the spirit and functionality of the present disclosure.

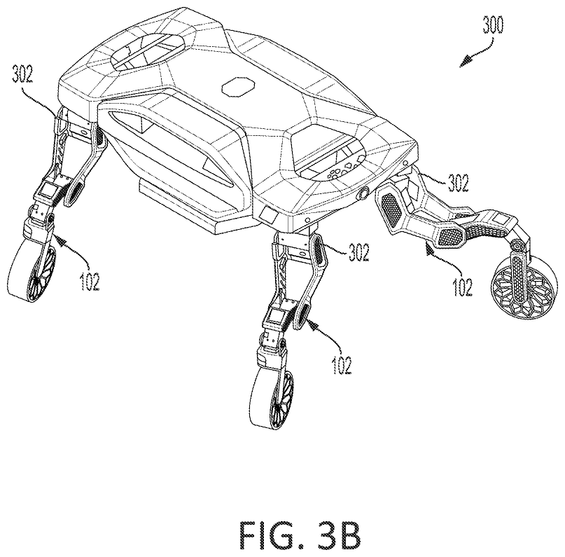

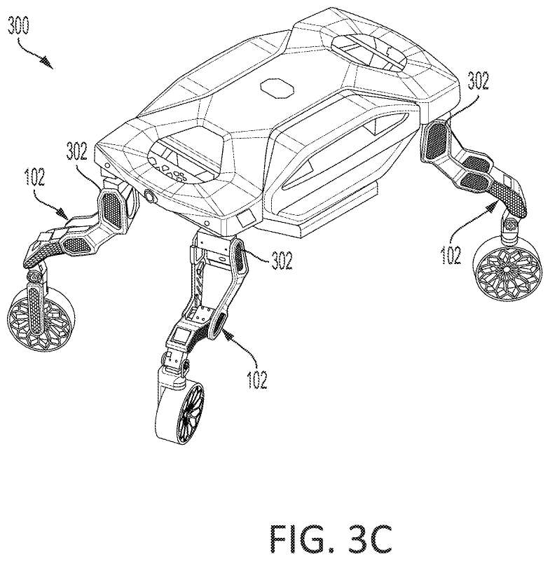

Referring now to FIGS. 3A through 3C, perspective views of different walking gaits of a hybrid vehicle 300 are illustratively depicted, in accordance with exemplary embodiments of the present disclosure.

FIG. 3A illustrates an example view of a hybrid vehicle 300 operating in a mammalian walking gait, according to an exemplary embodiment of the present disclosure. According to an exemplary embodiment, while in a mammalian walking gait, the leg-wheel components 102 are positioned in a support position below a hip section 302, allowing more of the reaction force to translate axially through each link rather than in shear load. In this position, each leg-wheel component 102 may function closer to a singularity, meaning that, for a given change in a joint 210 angle, an end effector will move relatively little. This results in a relatively energy efficient gait which is well suited for moderate terrain over longer periods of time, but may not be as stable because of the narrower stance of the hybrid vehicle 300.

FIG. 3B illustrates an example view of a hybrid vehicle 300 operating in a reptilian walking gait, according to an exemplary embodiment of the present disclosure. According to an exemplary embodiment, a reptilian walking gait may be configured to generally mirror how animals such as a lizard or gecko might traverse terrain. In this position, the reptilian walking gait may rely more heavily on one or more hip abduction motors which may be configured to swing the leg-wheel components 102 around a vertical axis, maintaining a wider stance. The reptilian gait position results in a higher level of stability and control over movement, but is less energy efficient. The wide stance results in high static loads on each motor, making the reptilian gait best suited for walking across extremely unpredictable, rugged terrain for short periods of time.

FIG. 3C illustrates an example view of a hybrid vehicle 300 operating in a hybrid walking gait, according to an exemplary embodiment of the present disclosure. In addition to reptilian and mammalian gaits, a variety of variants combining various gait strategies are possible. These variants may be generated through optimization techniques and/or discovered through simulation and machine learning. These hybrid gaits allow the hybrid vehicle 300 to optimize around the strengths and weaknesses of the more static bio-inspired gaits, transitioning to a more mammalian-style gait when terrain is gentler and to a more reptilian-style gait in extremely rugged and/or dynamic environments. In dynamic and highly variable terrains, the hybrid vehicle 300 may be configured to constantly adjust its gait based on the environment, battery charge, and/or any number of other factors.

In accordance with the described embodiments, wheeled locomotion may be available for use in situations where traditional vehicle travel using rolling wheels is available (e.g., roads and highways). Wheeled locomotion is efficient, when available, for conveyance of a hybrid vehicle (e.g., hybrid vehicles 100, 300, 500, 600, 610a, 610b, 610c, 650, 660, 700) between destinations. In some embodiments, the leg-wheel components 102 may be configured to allow for active height adjustment of the hybrid vehicle when transitioning from street use to off-road use.

In walking locomotion, the hybrid vehicle may be configured to walk up elevations and terrain that may not be surmountable using wheeled locomotion. In some instances, walking locomotion may allow for nimble and quiet motion, relative to wheeled locomotion. The hybrid vehicle may also be capable of moving laterally, allowing for quadrupedal ambulation.

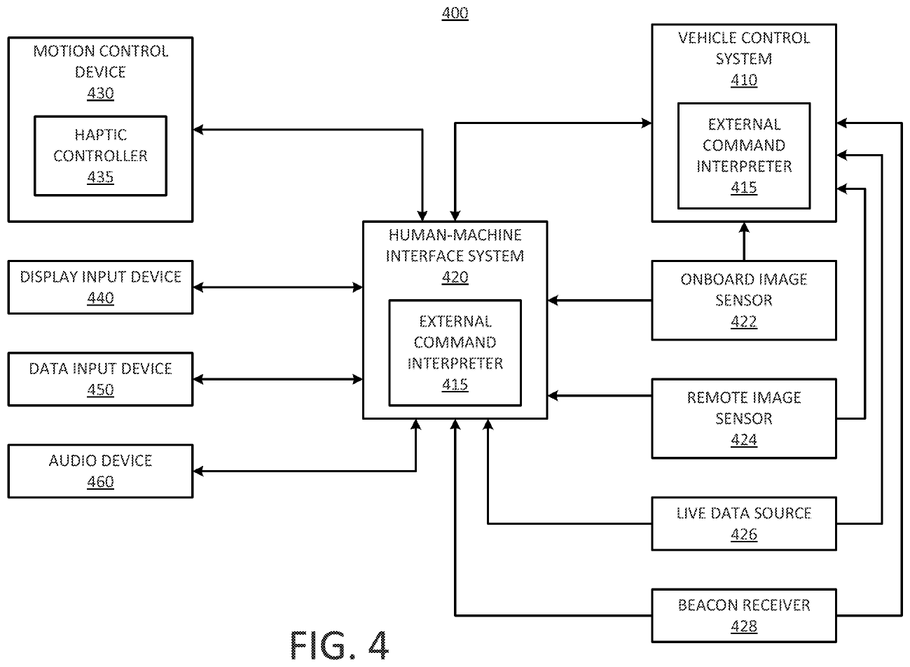

Referring now to FIG. 4, a block diagram of system 400 for providing a stability indication of a hybrid vehicle (e.g., hybrid vehicles 100, 300, 500, 600, 610a, 610b, 610c, 650, 660, 700) is illustratively depicted, in accordance with an exemplary embodiment of the present disclosure. FIG. 4 illustrates one example of a system 400 that can be used in accordance with or to implement various embodiments which are discussed herein.

In controlling the operation of a hybrid vehicle described herein, a number of aspects of the operation are subject to different types of operator control. For example, aspects that may be controlled in operating a hybrid vehicle may comprise the objectives of the hybrid vehicle, the destination of the hybrid vehicle, the speed and direction of travel of the hybrid vehicle, the type of locomotion used (e.g., wheeled, walking, or a combination), the position of legs when in walking locomotion, controlling the walking gait when in walking locomotion, etc. Embodiments described herein may configured to provide supplementary control modes for control of a hybrid vehicle.

According to an exemplary embodiment, the system 400 may comprise a vehicle control system 410 and a human-machine interface (HMI) system 420. The vehicle control system 410 may be configured to control movement and motion of the hybrid vehicle responsive to one or more received inputs. It should be appreciated that the one or more received inputs may comprise, without limitation, commands received from a human operator, either onboard the hybrid vehicle or remote, from an autonomous control system, and/or a combination thereof. It should be further appreciated that vehicle control system 400 may comprise multiple controllers and/or control modules, and that the functionality of each controller and/or control module may be arranged within one or more different combinations of controllers, resulting in movement of the hybrid vehicle.

The vehicle control system 410 may be configured to receive commands for movement and control of a hybrid vehicle. These commands may comprise, without limitation, mission objectives, vehicle destination, a speed and direction of travel, a locomotion mode (e.g., wheeled, walking, or a combination), motor positions of wheel-leg components, etc. The leg-wheel components 102 may comprise different walking modes. In addition to walking locomotion and rolling locomotion, the wheel motors 214 may be configured to be used while walking in order to create a hybrid wheeled-walking mode of locomotion. Under rolling locomotion, the leg-wheel components 102 may be configured to operate as a high range of motion suspension. It should be appreciated that vehicle control system 410 may be configured to receive commands from a human operator and/or non-human input, such as another hybrid vehicle.

The HMI system 420 may be configured to receive commands from a human operator, either onboard or remote, for controlling the hybrid vehicle via the vehicle control system 410. The HMI system 420 may be configured to receive and present information from the vehicle control system 410 for informing the operator of various information regarding the control and operation of the hybrid vehicle.

The HMI system 420 may be configured to receive commands from various input/output devices, such as, e.g., a motion control device 430, a display device 440, a data input device 450, and/or an audio device 460. The motion control device 430 may comprise, e.g., a steering wheel or a joystick for receiving motion commands from the operator for controlling movement and operation of the hybrid vehicle. It should be appreciated that the motion commands may comprise commands to move to a particular destination, use a particular locomotion mode, move at a certain speed, etc. According to an exemplary embodiment, the motion control device 430 may comprise a haptic controller 435 configured to provide haptic feedback to the operator.

Referring still to FIG. 4, the display device 440 of FIG. 4 may comprise a liquid crystal device (LCD), light emitting diode display (LED) device, plasma display device, a touch screen device, and/or other suitable display device suitable for creating graphic images and alphanumeric characters recognizable to a user.

The data input device 450 may comprise a touch device and/or a touch interface for receiving inputs of a human operator. According to an exemplary embodiment, the system 400 may comprise a plurality of data input devices 450 which may be located on one or more external surfaces of the hybrid vehicle. For example, the hybrid vehicle may comprise touch interfaces on each leg-wheel component 102, each portion of each leg-wheel component 102, the chassis, and/or any combination thereof. Touch control may be specific to a particular leg-wheel component 102, and/or may instantiate a central touch control (such as, e.g., for very small or very large vehicles). It should be appreciated that additional information may be conveyed through the touch interface using taps, swipes and/or other known gestures (e.g., for security, actuation, selection, fine control, etc.). Moreover, the touch interfaces may comprise one or more display devices (e.g., a touch screen) capable of displaying information, and/or may be touch only interfaces without an integrated display device.

According to some exemplary embodiments, the data input device 450 may be configured to allow for the explicit control of a visible symbol (e.g., a cursor) on the display device 440 and may be configured to indicate user selections of selectable items displayed on the display device 440. Many implementations of the data input device 450 are known in the art including, e.g., a trackball, mouse, touch pad, touch screen, joystick, and/or special keys on an alphanumeric input device capable of signaling movement of a given direction or manner of displacement. Alternatively, it will be appreciated that a cursor may be directed and/or activated via input from an alphanumeric input device using special keys and key sequence commands. According to an exemplary embodiment, the data input device 450 and the display device 440 may be configured to operate cooperatively as a touch screen device.

The audio device 460 may be configured to allows for an audio presentation of information to an operator. According to some exemplary embodiments, the audio device 460 may comprise a speaker. According to some exemplary embodiments, the audio device 460 may comprise a microphone configured for receiving, e.g., voice commands from a user.

According to an exemplary embodiment, the motion control device 430, the display device 440, the data input device 450, and/or the audio device 460, and/or any combination thereof (e.g., user interface selection devices), may be configured to collectively operate to provide a graphical user interface (GUI) under the direction of a processor. The GUI may be configured to enable a user to interact with the system 400 through one or more graphical representations presented on the display device 440 by interacting with one or more of the motion control device 430, the display device 440, the data input device 450, and/or the audio device 460.

According to an exemplary embodiment, the HMI system 420 may comprise an external command interpreter 415 configured for interpreting one or more commands received during a supplementary control mode, such as, e.g., a sign mode, a follow mode, or a touch mode. According to an exemplary embodiment, in the sign mode, an operator external to the hybrid vehicle may control operation of the hybrid vehicle by issuing one or more commands using, e.g., sign language. According to an exemplary embodiment, in the follow mode, one or more hybrid vehicles (e.g., one or more subservient hybrid vehicles) may be configured to follow a lead hybrid vehicle which may be configured to control operations of the one or more subservient hybrid vehicles. According to an exemplary embodiment, in the touch mode, a hybrid vehicle may be configured to be controlled through one or more touch interfaces on an exterior of the hybrid vehicle.

According to an exemplary embodiment, the system 400 may comprise an onboard image sensor 422, a remote image sensor 424, a live data source 426, and/or a beacon receiver 428. The onboard image sensor 422 may be located on the hybrid vehicle, and may be configured to capture a first person point of view (POV) (1P-POV) image. The remote image sensor 424 may be located on a second vehicle (e.g., an aerial vehicle) and may be configured to capture a second person POV (2P-POV) image. The remote image sensor 424 may be configured to be capable of viewing the hybrid vehicle and an environment in which the hybrid vehicle is operating.

According to an exemplary embodiment, the image sensors may comprise one or more visual cameras. It should be appreciated that other types of imaging sensors may be used based on the context (e.g., infrared, radar, sonar, ultrasonic, etc.). Furthermore, it should be appreciated that each hybrid vehicle can may comprise more than one sensor. For instance, the hybrid vehicle may comprise a front image sensor and a rear image sensor configured for capturing front image data and rear image data, respectively.

According to an exemplary embodiment, live data may be received from at least one live data source 426. The live data source 426 may comprise real time data and/or near real time data that may further characterize at least one of one or more perspectives and may be at least partially generated external to the hybrid vehicle. For a roadway context, the live data may comprise traffic data that may be superimposed to more static map data of different perspective views. For a firefighting context, the live data may comprise data on fire spread and/or containment along with weather data superimposed across the perspectives. In a low visibility environment (e.g., a snowstorm), the live data may combine lower quality live images with recorded images during better conditions that are registered by one or more location sensors (e.g., GPS) and map orientation. It should be appreciated that many other types of data source are possible.

The beacon receiver 428 may be configured to receive control information from another hybrid vehicle, in which the other hybrid vehicle is instantiating a follow mode in which one or more subservient hybrid vehicles follow a lead vehicle which controls operations of the subservient hybrid vehicles.

The external command interpreter 415 may be configured to interpret one or more commands received during a supplementary control mode, such as, e.g., a sign mode, a follow mode, and/or a touch mode. It should be appreciated that the external command interpreter 415 may be included within one or both of the vehicle control system 410 (e.g., for receiving non-human generated commands) and the HMI interface 420 (e.g., for interpreting human operator provided commands).

For instance, during the sign mode, at least one of the onboard image sensor 422 and the remote image sensor 424 may be configured to capture sign language expressed through manual articulations of a human operator. The sign language may be received at the external command interpreter 415 which may be configured to interpret the sign language to form one or more commands. The sign mode may not require an external device to be used, and may allow for control of a hybrid vehicle without any electronic or data connection to the hybrid vehicle. For example, such control may be useful due to a high noise environment (e.g., firefighting) or a low noise environment (e.g., a military stealth mission) in which a hybrid vehicle may be used. It should be appreciated that the sign language used may be universal, such as, e.g., American Sign Language (ASL), specific to a situation, and/or coded for additional security (e.g., signs used by players and managers in sports).

According to an exemplary embodiment, during the follow mode, a lead vehicle may be configured to control operations of one or more subservient hybrid vehicles. The follow mode may be engaged by using a beacon carried on the lead vehicle (e.g., an electronic beacon device or other communication device) with commands being received at the beacon receiver 428. According to an exemplary embodiment, the follow mode may be engaged using sign language, as described in the sign mode, and captured by at least one of onboard image sensor 422 and remote image sensor 424. According to an exemplary embodiment, the follow mode may be instantiated by the lead vehicle using a paint and/or equivalent material configured to create a path or other instruction that is imaged by at least one of the onboard image sensor 422 and the remote image sensor 424 of a subservient vehicle and may be interpreted using the external command interpreter 415 in order to identify one or more commands of the deposited material. Such deposited material may be temporary or permanent, and may be of a visible material and/or an invisible material (to the human eye) and may be configured to utilize a special image sensor or filter in order to be captured (e.g., ultraviolet paint). The one or more commands identified by the deposited material may be active for a period of time different from a period of visibility of the deposited material. According to an exemplary embodiment, the lead vehicle may be configured to use the follow mode by issuing one or more commands using one or more ambulatory limbs (e.g., leg-wheel components 102) of the lead vehicle. For example, the subservient vehicle that is controlled by the follow mode may be configured to perform preparatory work by, e.g., carrying gear and equipment for a team on a mission.

According to an exemplary embodiment, during the touch mode, a hybrid vehicle may be configured to be controlled through one or more touch interfaces (e.g., the one or more data input devices 450) on an exterior of the hybrid vehicle. In such an exemplary embodiment, an operator of the hybrid vehicle may touch the one or more touch interfaces on the hybrid vehicle in order to pick-and-place its leg-wheel components 102 and/or perform one or more other control functions. It should be appreciated that the hybrid vehicle may comprise one or more touch interfaces on each leg-wheel component 102, each portion of each leg-wheel component, the chassis, and/or any combination thereof. For example, the touch control may be limb specific, or instantiate a central touch control (such as, e.g., for very small or very large vehicles). It should be appreciated that additional information may be conveyed through the touch interface using, e.g., taps, swipes, and/or other known gestures (e.g., for security, actuation, selection, fine control, etc.) Moreover, the touch interfaces may comprise one or more display devices (e.g., a touch screen) capable of displaying information, or may be touch only interfaces without an integrated display device.

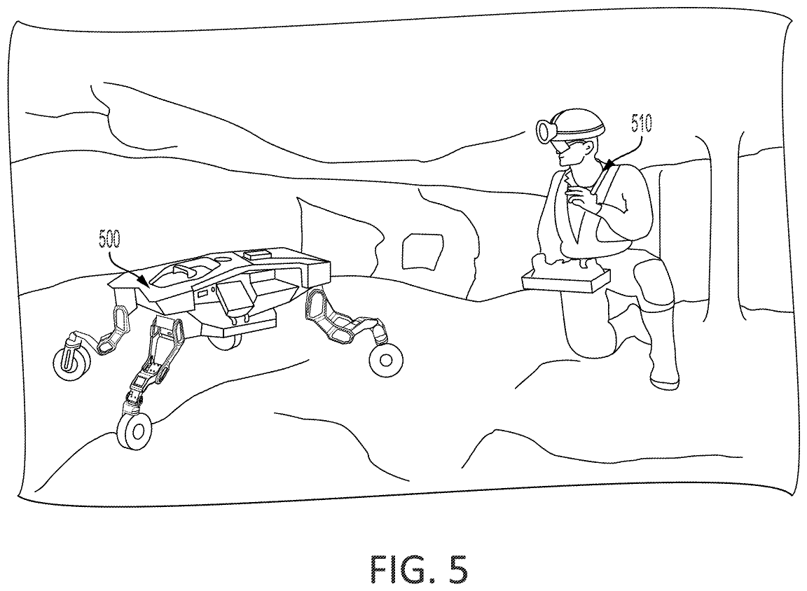

Referring now to FIG. 5, a diagram illustrating a hybrid vehicle 500 operating in sign mode is illustratively depicted, in accordance with an exemplary embodiment.

As illustrated, in the sign mode, an operator 510, external to the hybrid vehicle 500, controls operation of the hybrid vehicle 500 by issuing commands using sign language. The sign language may be captured by at least one image sensor of the hybrid vehicle 500 (e.g., at least one of an onboard image sensor 422 and a remote image sensor 424) and may be interpreted in order to form one or more commands at a human-machine interface (e.g., a HMI system 420) of the hybrid vehicle 500. According to an exemplary embodiment, the sign mode may not require an external device to be used, and may allow for control of the hybrid vehicle 500 without any electronic or data connection to the hybrid vehicle 500. For example, such control may be useful due to a high noise environment (e.g., firefighting or in a mining operation) and/or a low noise environment (e.g., a military stealth mission) in which the hybrid vehicle 500 is used. It should be appreciated that the sign language used may be universal, such as, e.g., American Sign Language (ASL), specific to a situation, and/or coded for additional security (e.g., signs used by players and managers in sports).

According to an exemplary embodiment, in a follow mode, one or more hybrid vehicles (e.g., subservient hybrid vehicles 610a, 610b, 610c) may be configured to follow a lead vehicle (e.g., lead hybrid vehicle 600) which may be configured to control operations of the subservient hybrid vehicles 610a, 610b, 610c.

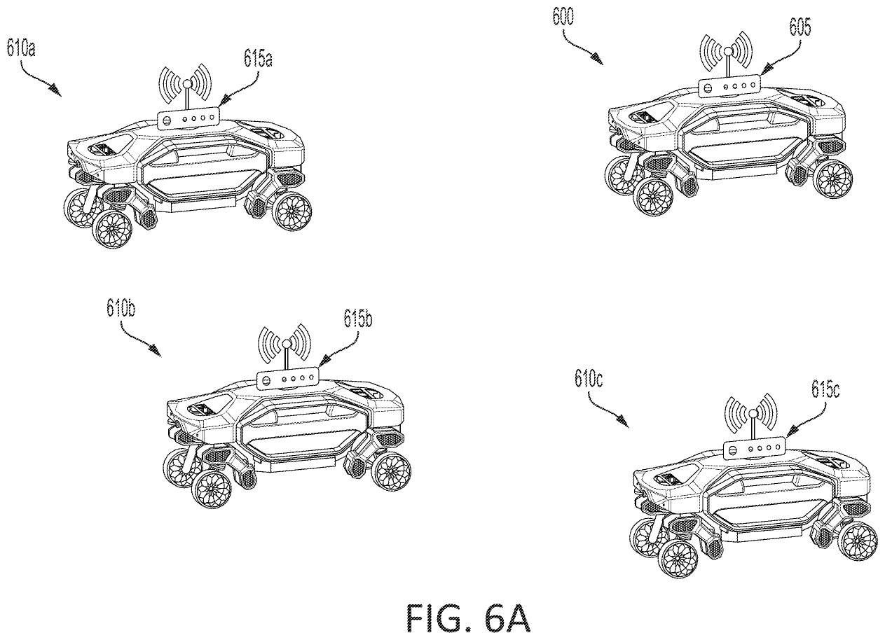

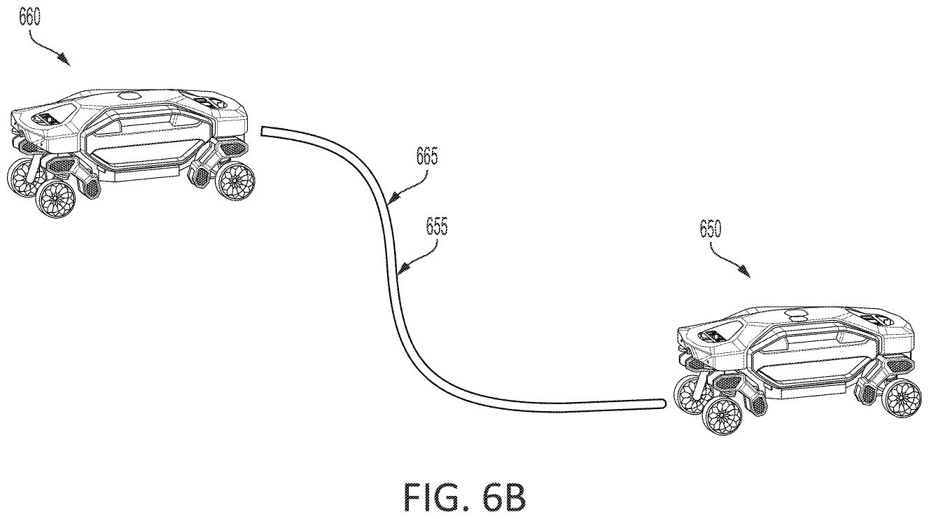

As illustrated in FIG. 6A, the follow mode may be engaged by using a beacon 605 carried on the lead hybrid vehicle 600 (e.g., an electronic beacon device and/or other communication device). One or more commands may be relayed to the subservient hybrid vehicles 610a, 610b, and 610c through one or more beacon receivers 615a, 615b, and 615c, respectively. It should be appreciated that there may be any number of lead and/or subservient hybrid vehicles while maintaining the spirit and functionality of the present disclosure. According to an exemplary embodiment, any vehicle may be a lead vehicle by relaying one or more commands to one or more other vehicles.

As illustrated in FIG. 6B, according to an exemplary embodiment, the follow mode may be instantiated by a lead hybrid vehicle 650 using a paint and/or equivalent material 655 in order to create a path 665 or other instruction that is imaged at an image sensor (e.g., at least one of an onboard image sensor 422 and a remote image sensor 424) of a subservient vehicle 660 and interpreted using a vehicle control system (e.g., vehicle control system 410) to identify one or more commands of the deposited material 655. Such deposited material 655 may be temporary or permanent, and may be of a visible material or an invisible material (to the human eye) and may be configured to utilize a special image sensor or filter to capture (e.g., ultraviolet paint). The one or more commands identified by the deposited material 655 may be active for a period of time different from the period of visibility of the deposited material 655.

According to an exemplary embodiment, the lead hybrid vehicle 650 may be configured to use the follow mode by, e.g., issuing one or more commands using one or more ambulatory limbs (e.g., leg-wheel components 102) of the lead hybrid vehicle 650. For example, the subservient hybrid vehicle 660 that is controlled by the follow mode may be configured to perform preparatory work by, e.g., carrying gear and equipment for a team on a mission.

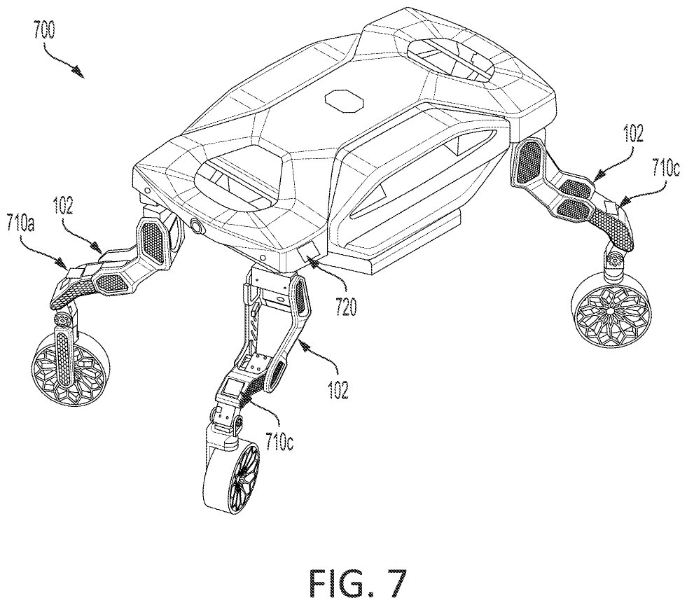

Referring now to FIG. 7, a diagram illustrating a hybrid vehicle 700 operating in a touch mode is illustratively depicted, in accordance with an exemplary embodiment.

According to an exemplary embodiment, in the touch mode, the hybrid vehicle 700 may be configured to be controlled through one or more touch interfaces 710a, 710b, 710c, and 720 on an exterior of the hybrid vehicle 700. In such an exemplary embodiment, an operator of the hybrid vehicle 700 may touch the one or more touch interfaces 710a, 710b, 710c, and 720 on the hybrid vehicle 700 in order to pick-and-place its leg-wheel components 102 and/or in order to perform one or more other control functions. It should be appreciated that the hybrid vehicle 700 may comprise one or more touch interfaces on each leg-wheel component 102 (e.g., touch interfaces 710a, 710b, 710c, and 720), each portion of each leg-wheel component 102, the chassis (e.g., touch interface 720), and/or any combination thereof. For example, the touch control may be limb specific, and/or may be instantiated by a central touch control (such as, e.g., for very small or very large vehicles). It should be appreciated that additional information may be conveyed through the touch interface using, e.g., taps, swipes, and/or other known gestures (e.g., for security, actuation, selection, fine control, etc.). Moreover, the touch interfaces 710a, 710b, 710c, and 720 may comprise one or more display devices (e.g., a touch screen) configured to display information, and/or be touch only interfaces without an integrated display device.

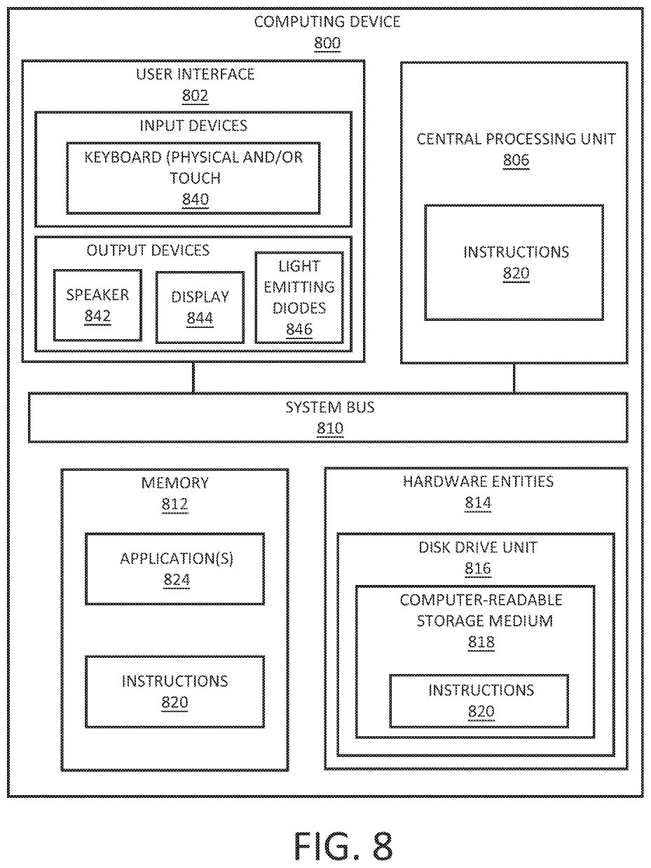

Referring now to FIG. 8, an illustration of an example architecture for a computing device 800 is provided. According to an exemplary embodiment, one or more functions of the present disclosure may be implemented by a computing device such as, e.g., computing device 800 or a computing device similar to computing device 800.

The hardware architecture of FIG. 8 represents one example implementation of a representative computing device configured to perform one or more methods and means for controlling a vehicle capable of locomotion using both walking motion and rolling traction, as described herein. As such, the computing device 800 of FIG. 8 implements at least a portion of the method(s) described herein and/or implements at least a portion of the functions of the system(s) described herein (e.g., system 400 of FIG. 4).

Some or all components of the computing device 800 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 8, the computing device 800 may comprise a user interface 802, a Central Processing Unit (“CPU”) 806, a system bus 810, a memory 812 connected to and accessible by other portions of computing device 800 through system bus 810, and hardware entities 814 connected to system bus 810. The user interface may comprise input devices and output devices, which may be configured to facilitate user-software interactions for controlling operations of the computing device 800. The input devices may comprise, but are not limited to, a physical and/or touch keyboard 840. The input devices may be connected to the computing device 800 via a wired or wireless connection (e.g., a Bluetooth® connection). The output devices may comprise, but are not limited to, a speaker 842, a display 844, and/or light emitting diodes 846.

At least some of the hardware entities 814 may be configured to perform actions involving access to and use of memory 812, which may be a Random Access Memory (RAM), a disk driver and/or a Compact Disc Read Only Memory (CD-ROM), among other suitable memory types. Hardware entities 814 may comprise a disk drive unit 816 comprising a computer-readable storage medium 818 on which may be stored one or more sets of instructions 820 (e.g., programming instructions such as, but not limited to, software code) configured to implement one or more of the methodologies, procedures, or functions described herein. The instructions 820 may also reside, completely or at least partially, within the memory 812 and/or within the CPU 806 during execution thereof by the computing device 800.

The memory 812 and the CPU 806 may also constitute machine-readable media. The term “machine-readable media”, as used here, refers to a single medium or multiple media (e.g., a centralized or distributed database, and/or associated caches and servers) that store the one or more sets of instructions 820. The term “machine-readable media”, as used here, also refers to any medium that is capable of storing, encoding or carrying a set of instructions 820 for execution by the computing device 800 and that cause the computing device 800 to perform any one or more of the methodologies of the present disclosure.

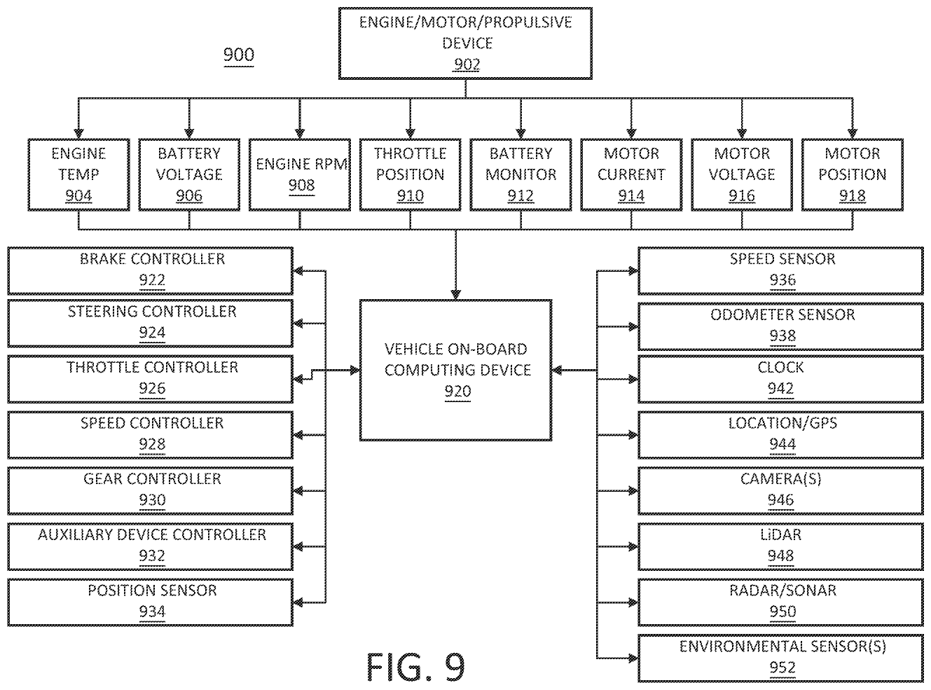

Referring now to FIG. 9, an example vehicle system architecture 900 for a vehicle is provided, in accordance with an exemplary embodiment of the present disclosure.

Hybrid vehicles 100, 300, 500, 600, 610a, 610b, 610c, 650, 660, and 700 may have the same or similar system architecture as that shown in FIG. 9. Thus, the following discussion of vehicle system architecture 900 is sufficient for understanding one or more components of hybrid vehicles 100, 300, 500, 600, 610a, 610b, 610c, 650, 660, and 700.

As shown in FIG. 9, the vehicle system architecture 900 may comprise an engine, motor or propulsive device (e.g., a thruster) 902 and various sensors 904-918 for measuring various parameters of the vehicle system architecture 900. In gas-powered or hybrid vehicles having a fuel-powered engine, the sensors 904-918 may comprise, for example, an engine temperature sensor 904, a battery voltage sensor 906, an engine Rotations Per Minute (RPM) sensor 908, and/or a throttle position sensor 910. If the vehicle is an electric or hybrid vehicle, then the vehicle may comprise an electric motor, and accordingly may comprise sensors such as a battery monitoring system 912 (to measure current, voltage and/or temperature of the battery), motor current 914 and voltage 916 sensors, and motor position sensors such as resolvers and encoders 918.

Operational parameter sensors that are common to both types of vehicles may comprise, for example: a position sensor 934 such as an accelerometer, gyroscope and/or inertial measurement unit; a speed sensor 936; and/or an odometer sensor 938. The vehicle system architecture 900 also may comprise a clock 942 that the system uses to determine vehicle time and/or date during operation. The clock 942 may be encoded into the vehicle on-board computing device 920, it may be a separate device, or multiple clocks may be available.

The vehicle system architecture 900 also may comprise various sensors that operate to gather information about the environment in which the vehicle is traveling. These sensors may comprise, for example: a location sensor 944 (for example, a Global Positioning System (GPS) device); object detection sensors such as one or more cameras 946; a LiDAR sensor system 948; and/or a RADAR and/or a sonar system 950. The sensors also may comprise environmental sensors 952 such as, e.g., a humidity sensor, a precipitation sensor, a light sensor, and/or ambient temperature sensor. The object detection sensors may be configured to enable the vehicle system architecture 900 to detect objects that are within a given distance range of the vehicle in any direction, while the environmental sensors 952 may be configured to collect data about environmental conditions within the vehicle's area of travel.

During operations, information may be communicated from the sensors to an on-board computing device 920 (e.g., computing device 800 of FIG. 8). The on-board computing device 920 may be configured to analyze the data captured by the sensors and/or data received from data providers and may be configured to optionally control operations of the vehicle system architecture 900 based on results of the analysis. For example, the on-board computing device 920 may be configured to control: braking via a brake controller 922; direction via a steering controller 924; speed and acceleration via a throttle controller 926 (in a gas-powered vehicle) or a motor speed controller 928 (such as a current level controller in an electric vehicle); a differential gear controller 930 (in vehicles with transmissions); and/or other controllers. The brake controller 922 may comprise a pedal effort sensor, pedal effort sensor, and/or simulator temperature sensor, as described herein.

Geographic location information may be communicated from the location sensor 944 to the on-board computing device 920, which may then access a map of the environment that corresponds to the location information to determine known fixed features of the environment such as streets, buildings, stop signs and/or stop/go signals. Captured images from the cameras 946 and/or object detection information captured from sensors such as LiDAR 948 may be communicated from those sensors to the on-board computing device 920. The object detection information and/or captured images may be processed by the on-board computing device 920 to detect objects in proximity to the vehicle. Any known or to be known technique for making an object detection based on sensor data and/or captured images may be used in the embodiments disclosed in this document.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A hybrid vehicle, comprising:
a chassis;
a plurality of leg-wheel components coupled to the chassis, wherein the plurality of leg-wheel components are configured to be collectively operable to provide wheeled locomotion and walking locomotion;
at least one sensor configured to receive one or more external commands during a supplementary control mode; and
an external command interpreter configured to:
interpret the one or more external commands; and
direct a vehicle control system,
wherein the vehicle control system is configured to control a hybrid vehicle to effectuate the one or more external commands.

2. The hybrid vehicle of claim 1, wherein:
the supplementary control mode comprises a sign mode,
in the sign mode, the hybrid vehicle is configured to be controlled by an operator, external to the hybrid vehicle, and
the operator is configured to control operation of the hybrid vehicle by issuing the one or more external commands using sign language.

3. The hybrid vehicle of claim 2, wherein the at least one sensor comprises an image sensor.

4. The hybrid vehicle of claim 1, wherein:
the supplementary control mode comprises a follow mode,
in the follow mode, the hybrid vehicle is configured to follow a lead vehicle, and
the lead vehicle is configured to control operations of the hybrid vehicle.

5. The hybrid vehicle of claim 4, wherein the at least one sensor comprises an image sensor.

6. The hybrid vehicle of claim 5, wherein the one or more external commands are issued by the lead vehicle by a material deposition.

7. The hybrid vehicle of claim 4, wherein the at least one sensor comprises a beacon receiver.

8. The hybrid vehicle of claim 7, wherein the one or more external commands are issued by the lead vehicle by a beacon transmitter.

9. The hybrid vehicle of claim 1, wherein the at least one sensor comprises a touch sensor on an external surface of the hybrid vehicle.

10. The hybrid vehicle of claim 9, further comprising one or more touch sensors, and wherein:
the supplementary control mode comprises a touch mode, and
in the touch mode, the hybrid vehicle is configured to be controlled through the one or more touch sensors.

11. A system for controlling a hybrid vehicle, comprising:
a hybrid vehicle, comprising:
a chassis;
a plurality of leg-wheel components coupled to the chassis, wherein the plurality of leg-wheel components are configured to be collectively operable to provide wheeled locomotion and walking locomotion;
at least one sensor configured to receive one or more external commands during a supplementary control mode;
a vehicle control system configured to control the hybrid vehicle to effectuate the one or more external commands; and
a computing device, comprising a processor and a memory, configured to store programming instructions that, when executed by the processor, cause the processor to:
using an external command interpreter:
interpret the one or more external commands; and
direct the vehicle control system to effectuate the one or more external commands.

12. The system of claim 11, wherein:
the supplementary control mode comprises a sign mode,
in the sign mode, the hybrid vehicle is configured to be controlled by an operator, external to the hybrid vehicle, and
the operator is configured to control operation of the hybrid vehicle by issuing the one or more external commands using sign language.

13. The system of claim 12, wherein the at least one sensor comprises an image sensor.

14. The system of claim 11, further comprising a lead vehicle, wherein:
the supplementary control mode comprises a follow mode,
in the follow mode, the hybrid vehicle is configured to follow the lead vehicle, and
the lead vehicle is configured to control operations of the hybrid vehicle.

15. The system of claim 14, wherein the at least one sensor comprises an image sensor.

16. The system of claim 15, wherein the lead vehicle is configured to issue the one or more external commands by a material deposition.

17. The system of claim 14, wherein the at least one sensor comprises a beacon receiver.

18. The system of claim 17, wherein the lead vehicle is configured to issue the one or more external commands by a beacon transmitter.

19. The system of claim 11, wherein the at least one sensor comprises a touch sensor on an external surface of the hybrid vehicle.

20. The system of claim 19, wherein:
the hybrid vehicle comprises one or more touch sensors,
the supplementary control mode comprises a touch mode, and
in the touch mode, the hybrid vehicle is configured to be controlled through the one or more touch sensors.
